(19) United States
(12) Patent Application Publication
(10) Pub. No.: US 2026/0184922 A1
(43) Pub. Date: Jul. 2, 2026

(54) A POLYSILOXANE COMPOSITION

(71) Applicant: WACKER CHEMIE AG, Munich (DE)

(72) Inventors: Junshan Yin, Shanghai (CN); Haigang KANG, Shanghai (CN)

(73) Assignee: WACKER CHEMIE AG, Munich (DE)

(21) Appl. No.: 19/128,184

(22) PCT Filed: Nov. 12, 2022
(86) PCT No.: PCT/CN2022/131569

§ 371 Date: May 8, 2025

(51) Int. Cl. C08L 83/04; C08G 77/44; C08K 3/22; C08K 5/5419

(52) U.S. Cl. CPC C08L 83/04; C08K 3/22; C08K 5/5419; C08G 77/44; C08K 2003/2227; C08K 2201/001; C08L 2203/20; C08L 2205/025

(57) ABSTRACT

The present invention relates to an organosilicon composition with low viscosity and thixotropic index under the condition of high filling rate, which contains vinyl silicone oil, heat conductive filler, silane compound and polysiloxane. The composition can be used in the technical field of thermally conductive materials.

The present invention relates to an organosilicon composition with low viscosity and thixotropic index under the condition of high filling rate, which contains vinyl silicone oil, heat conductive filler, silane compound and polysiloxane. The composition can be used in the technical field of thermally conductive materials.

The present invention relates to an organosilicon composition with low viscosity and thixotropic index under the condition of high filling rate, which contains vinyl silicone oil, heat conductive filler, silane compound and polysiloxane. The composition can be used in the technical field of thermally conductive materials.

### TECHNICAL FIELD

The present invention relates to the technical field of thermal conductive silicone compositions.

### BACKGROUND

CN113840881A discloses a thermal interface material, which contains long-chain alkyl single-end hydroxyl terminated silicone oil, long-chain alkyl silicone oil, long-chain alkyl vinyl terminated silicone oil and heat conductive filler. In particular, the composition may also contain one or more silane coupling agents. Long-chain alkyl single-end hydroxyl terminated silicone oil contains long-chain alkyl branches. The general formula of the silane coupling agent is: Y—(CH₂)ₙ—Si—X₃, wherein Y is an organic functional group, X is a hydrolyzable group, and n is 10-20. That is, CN113840881A discloses that long-chain alkyl single-end hydroxyl terminated silicone oil and long alkyl silane coupling agent can be used in the thermal interface composition, wherein the number of carbon atoms in the long alkyl groups is generally greater than or equal to 10.

U.S. Pat. No. 6,169,142 discloses a thermally conductive silicone rubber composition containing vinyl silicone oil, hydrogen-containing silicone oil, alumina heat conductive filler and long-chain alkyl alkoxysilane R¹ₐSi(OR²)₍₄₋ₐ₎, wherein R¹ is C6-20 hydrocarbon group. Table 2 specifically lists the comparative experiments of Ex.6 and CE2. The Ex.6 product (obtained with hexyltrimethoxysilane) has a lower viscosity than CE2 (obtained with methyltriethoxysilane) at 100° C.

Currently, when potting devices with complex structures and narrow gaps, there is a need to obtain a composition with lower flow properties at different shear rates. Better fluidity can reduce the shortcomings of insufficient flow of the potting glue and avoid air bubbles and shrinkage cavities.

### SUMMARY OF INVENTION

The present invention discloses a composition having a lower thixotropic index (lower thixotropy) at high loadings. And under both high shear and low shear conditions, the composition has a lower viscosity.

In the present invention, high shear refers to a shear rate of 10 (1/s); and low shear refers to a shear rate of 1 (1/s).

The present invention provides a composition, which contains:
a component (A), that is an organopolysiloxane, preferably a component (A-1) that is an organopolysiloxane having two or more alkenyl groups per molecule;
optional a component (B) that is an organohydrogenpolysiloxane having two or more hydrogen atoms directly bonded to silicon atoms and is contained in such an amount that the number of moles of hydrogen atoms directly bonded to silicon atoms in the component (B) is 0.1 to 5.0 times the number of moles of alkenyl groups derived from the component (A-1);
a component (C) that is a heat conductive filler,
wherein the filling rate of the heat conductive filler is greater than or equal to 0.80, preferably greater than or equal to 0.84, preferably greater than or equal to 0.88, preferably greater than or equal to 0.89, preferably greater than or equal to 0.90;
optional a component (D) that is a platinum group metal-based curing catalyst having a platinum group metal element content of 0.1 to 1,000 ppm relative to the component (A-1) based on mass,
a component (E-1) that is an alkoxysilane compound shown by the following formula (1); and

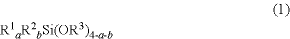

in the formula (1)
each R¹ independently represents an alkyl group having 1 to 3 carbon atoms, preferably methyl, ethyl,
each R² independently represents an unsubstituted or substituted hydrocarbon group having 1 to 3 carbon atoms, preferably methyl, ethyl,
each R³ independently represents an alkyl group having 1 to 6 carbon atoms, preferably an alkyl group having 1 to 3 carbon atoms, more preferably methyl, ethyl,
a represents an integer of 1 to 3, and b represents an integer of 0 to 2, provided that a+b is an integer of 1 to 3,
a component (E-2) that is a polysiloxane represented by the following general formula (2),

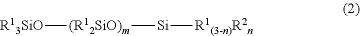

in the formula (2),
each R¹ independently represents a hydrocarbon group with 1-6 carbon atoms, preferably s an alkyl or alkenyl group having 1 to 3 carbon atoms, preferably methyl, ethyl, propyl, vinyl, more preferably methyl;
each R² independently represents —OH or —(CH₂)ₚOH, p is an integer from 1 to 3, preferably hydroxyl;
m≤50, more preferably m≤20, more preferably 6≤m≤18, for example 8, 10, 12, 14, 16;
n is an integer, preferably n is 1-3, more preferably n is 1.

For the composition as described above, according to DIN53019, the viscosity of ingredient (E-2) at 25° C. is 500 mPa·s or less, preferably 300 mPa·s or less, more preferably 100 mPa·s or less, more preferably 50 mPa·s or less, more preferably between 10-40 mPa·s.

According to NMR measurements, the Mn of ingredient (E-2) is less than or equal to 5000 g/mol, preferably less than or equal to 3000 g/mol, more preferably less than or equal to 2000 g/mol, more preferably between 500-1500 g/mol.

According to NMR measurement, the hydroxyl value of component (E-2) is 10 wt % or less, preferably 5 wt % or less, more preferably 3 wt % or less, more preferably 1.0-2.8 wt %.

For the composition as described above, its thixotropic index (Ti) at 25° C. is 1.70 or less, preferably 1.05-1.70, more preferably 1.20-1.70, more preferably 1.30-1.55. When it exceeds 1.70, insufficient leveling is likely to occur, and unfilled gaps are likely to be generated during potting of devices containing slits, which is not preferable.

In the present invention, the thixotropic index (Ti) is the ratio of the viscosity q1 at a shear rate of 1 (1/s) to the viscosity η₁₀ at a shear rate of 10 (1/s) at 25° C. using a rheometer (Ti=η₁/η₁₀) to define.

In the present invention, the ratio of (E-1) component to (C) component is between 0.02-1.00 wt %, preferably between 0.05-0.50 wt %, more preferably between 0.08-0.20 wt %, more preferably between 0.08-0.15 wt %.

The composition as above, wherein
the weight ratio of (E-2) component to (E-1) component is between 0.5-10, preferably between 1-6; preferably between 2-4; more preferably between 2.5-3.5; for example, 2.3, 2.7, 2.9, 3.1, 3.3, 3.7.

In the present invention, the ratio of (E-2) component to (C) component is between 0.05-1.00 wt %, preferably between 0.08-0.80 wt %, more preferably between 0.08-0.60 wt %, more preferably between 0.10-0.40 wt %.

In the present invention, the ratio of the sum of components (E-1) and (E-2) to component (C) is between 0.05-2.00 wt %, preferably between 0.08-1.20 wt %, more preferably between 0.10-1.00 wt %, more preferably between 0.10-0.80 wt %, more preferably between 0.20-0.60 wt %.

In the present invention, the amount of the thixotropic agent is less than or equal to 1 wt %, preferably less than or equal to 0.1 wt %, calculated based on the total amount of the composition being 100 wt %.

The thixotropic agent is selected from montmorillonite, bentonite or metal oxide particles with a BET specific surface area greater than or equal to 100 m²/g, preferably greater than or equal to 150 m²/g, such as fumed silica and precipitated silica.

A composition as above, wherein ingredient (C) is treated with ingredient (E-1) and ingredient (E-2).

The composition as described above, wherein the component (C) is subjected to the heating surface treatment of the component (E-1) and the component (E-2).

Use of the composition as described above in the field of potting.

In electronics, potting is a process of filling a complete electronic assembly with a liquid or gelatinous compositions for excluding gaseous phenomena such as corona discharge, for resistance to shock and vibration, and for the exclusion of water, moisture, or corrosive agents.

A thermally conductive member comprising above composition or a cured product thereof. A heat-dissipating structure comprising the thermally conductive member.

A heat-dissipating structure obtained by providing a heat-dissipating member via the composition or a cured product thereof on a heat-dissipating component or a circuit board including a mounted heat-dissipating component.

The heat-dissipating structure is an electrical device or electronic device.

The composition as described above, when the thermal conductivity is larger than 2.5 W/mk, at 25° C. according to DIN53019, when the shear rate is 1 (1/s), the initial viscosity of the composition after mixing is less than or equal to 100 Pa·s, preferably equal to or less than 60 Pa·s, and more preferably equal to or less than 40 Pa·s.

The composition as described above, when the thermal conductivity is larger than 2.5 W/mk, at 25° C. according to DIN53019, when the shear rate is 10 (1/s), the initial viscosity of the composition after mixing is less than or equal to 50 Pa·s, preferably equal to or less than 30 Pa·s, and more preferably equal to or less than 20 Pa·s.

The composition as described above, when the thermal conductivity is less than 2.5 W/mk, at 25° C. according to DIN53019, when the shear rate is 1 (1/s), the initial viscosity of the composition after mixing after mixing is less than or equal to 60 Pa·s, preferably equal to or less than 40 Pa·s, and more preferably equal to or less than 20 Pa·s.

The composition as described above, when the thermal conductivity is less than 2.5 W/mk, at 25° C. according to DIN53019, when the shear rate is 10 (1/s), the initial viscosity of the composition after mixing after mixing is less than or equal to 40 Pa·s, preferably equal to or less than 30 Pa·s, more preferably equal to or less than 20 Pa·s, and more preferably equal to or less than 10 Pa·s.

In the present invention, the filling rate=total heat conductive filler amount/total weight of the composition. Generally, the filling rate which is greater than or equal to 0.84 is considered as the high filling rate.

In present invention, a component (C) that is a heat conductive filler.

(C) component contains
10-30 wt % (C-1) aluminum hydroxide with an average particle diameter greater than or equal to 0.1 μm and less than or equal to 4 μm,
   for example (C-1) the average particle diameter is 0.8, 1.0, 1.2, 1.4, 1.6, 1.8, 2.0, 2.2, 2.4, 2.6, 2.8 μm, and the content is 18 wt %, 20 wt %, 22 wt %, 24 wt %, 26 wt %, 28 wt %;
10-30 wt % (C-2) aluminum hydroxide with an average particle diameter greater than or equal to 15 μm and less than or equal to 40 μm,
   for example (C-2) the average particle diameter is 18, 20, 22, 24, 26, 28, 30 μm and the content is 18 wt %, 20 wt %, 22 wt %, 24 wt %, 26 wt %, 28 wt %,
40-80 wt % (C-3) aluminum hydroxide with an average particle diameter greater than or equal to 80 μm and less than or equal to 100 μm,
   for example (C-3) the average particle diameter is 82, 84, 86, 88, 90, 92, 94, 96, 98 μm, and the content is 44 wt %, 46 wt %, 48 wt %, 50 wt %, 52 wt %, 54 wt %, 56 wt %, 58 wt %, 60 wt %, 62 wt %, 64 wt %,
in (C-1), (C-2) and (C-3), the component (C) in the composition is calculated as 100 wt %,

The composition as described above, wherein the total amount of all aluminum hydroxide is greater than 95 wt %, preferably greater than 99 wt %, more preferably greater than 99.9 wt %, and calculated based on the total amount of heat conductive filler being 100 wt %.

The composition as described above, wherein the total amount of all aluminum hydroxide is greater than 95 wt %, preferably greater than 99 wt %, and more preferably greater than 99.9 wt %, and the total amount of fillers is calculated as 100 wt %.

In the composition as described above, (C-1), (C-2) and (C-3) aluminum hydroxide is all in amorphous form.

In the composition as described above, the amount of the spherical filler is less than 10% by weight, preferably less than 1% by weight, calculated based on the weight of the composition as 100% by weight.

In the composition as described above, the amount of spherical alumina is less than 10% by weight, preferably less than 1% by weight, based on the weight of the composition as 100% by weight.

In the composition as described above, in (C-1), (C-2) and (C-3) aluminum hydroxide, the content of Al(OH)₃ is greater than or equal to 99.1%, preferably greater than or equal to 99.5%.

The composition as described above, wherein (C-1), (C-2) and (C-3) aluminum hydroxide, wherein the content of Na₂O is less than or equal to 0.1%, preferably the total content of water-soluble Na₂O and lattice state Na₂O is less than or equal to 0.1%.

The composition as described above, wherein (C) component contains
10-30 wt % (C-1) Aluminum hydroxide with an average particle diameter greater than or equal to 0.5 μm and less than or equal to 3 μm,
10-30 wt % (C-2) Aluminum hydroxide with an average particle diameter greater than or equal to 15 μm and less than or equal to 40 μm,
40-80 wt % (C-3) Aluminum hydroxide with an average particle diameter greater than or equal to 85 μm and less than or equal to 95 μm,
in (C-1), (C-2) and (C-3), the component (C) in the composition is calculated as 100% by weight.

The composition as described above, wherein component (C) contains
20-50 wt % (C-5) alumina with an average particle size greater than or equal to 1 μm and less than or equal to 10 μm,
50-80 wt % (C-6) alumina with an average particle size greater than or equal to 30 μm and less than or equal to 95 μm,
In (C-5) and (C-6), the component (C) in the composition is calculated as 100 wt %.

The definition of the average particle diameter refers to the value of the cumulative average particle diameter (D50 median diameter) measured by the particle size analyzer LS 13 320 manufactured by BECKMAN COULTER on a volume basis.

(C-1) sample is prepared by the solution method. 0.1 g sample is placed in 10 ml of absolute ethanol, dispersed by ultrasonic (100 w) and stirred for 2 minutes, so that the sample is fully dispersed. Take out 2-3 drops of sample solution and put them into the sample cell of the particle size analyzer.

(C-2) (C-3) (C-5) (C-6) samples (or other heat conductive fillers with an average particle diameter greater than or equal to 7 μm) are prepared by the dry powder method, and an appropriate amount of the sample dried at room temperature is placed into the loading cylinder of the particle size analyzer. Insert the loading cylinder into the detection slot of the device.

In the present invention, the particle size distribution of heat conductive fillers is unimodal, or their particle sizes meet unimodal or almost unimodal particle size distributions.

The almost unimodal particle size distributions in the present invention means that in the volume integral map of the measurement sample, there might be two or more peaks, but the volume integral area of the main peak accounts for more than 80% of the entire volume integral area, preferably more than 85%, more preferably more than 90%, more preferably more than 95%.

Spherical fillers, whose outer contour is generally spherical, are filler materials which are obtained from the amorphous fillers treated by chemical and/or physical (including heat treatment) processes.

Spherical alumina is a product obtained after heat treatment of amorphous alumina, and the outer contour is generally spherical.

In addition, the present invention provides a thermal conductive silicone cured product comprising a cured product of the thermal conductive silicone composition.

Such a thermally conductive silicone cured product is excellent in fluidity, thermal conductivity, and light weight.

As described above, according to the inventive thermal conductive silicone composition, a silicone composition containing specific organopolysiloxane, hydrogenpolysiloxane, and heat conductive filler is elaborately adjusted and formulated, so that the base material is filled with the heat conductive filler at high density. This makes it possible to provide a thermal conductive silicone composition which results in a thermal conductive silicone cured product having high thermal conduction and light weight. Such a thermal conductive silicone cured product is useful, particularly for cooling electronic parts through thermal conduction, as a heat conducting material in potting application.

As noted above, current invention creates a thermal conductive silicone cured product (thermal conductive gel molded product) having low viscosity, low thixotropy, high fluidity, high thermal conduction and light weight, and a thermal conductive silicone composition for forming the cured product.

Specifically, the present invention is a thermal conductive silicone composition comprising:

Component (A): Organopolysiloxane, preferably Component (A-1): Alkenyl Group-Containing Organopolysiloxane

The component (A) is an organopolysiloxane. The component (A) serves as a main component of the inventive composition. In general, the main chain portion is normally composed of repeated basic diorganosiloxane units, but this molecular structure may partially contain a branched structure, or may be a cyclic structure. Nevertheless, the main chain is preferably linear diorganopolysiloxane from the viewpoint of physical properties of the cured product, such as mechanical strength.

The component (A-1) is an alkenyl group-containing organopolysiloxane in which the number of silicon atom-bonded alkenyl groups is at least two per molecule. The component (A-1) serves as a main component of the inventive composition. In general, the main chain portion is normally composed of repeated basic diorganosiloxane units, but this molecular structure may partially contain a branched structure, or may be a cyclic structure. Nevertheless, the main chain is preferably linear diorganopolysiloxane from the viewpoint of physical properties of the cured product, such as mechanical strength.

Functional groups bonded to a silicon atom include an unsubstituted or substituted monovalent hydrocarbon group. Examples thereof include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the functional group include ones having 1 to 10 carbon atoms, and particularly typical examples thereof include ones having 1 to 6 carbon atoms. Preferable examples of the functional group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. Additionally, all the functional groups bonded to a silicon atom do not have to be the same. Furthermore, the alkenyl group normally has about 2 to 8 carbon atoms. Examples thereof include a vinyl group, an allyl group, a propenyl group, an isopropenyl group, a butenyl group, a hexenyl group, a cyclohexenyl group, etc. Among these, lower alkenyl groups, such as a vinyl group and an allyl group, are preferable and a vinyl group is particularly preferable. Note that the number of the alkenyl groups has to be two or more per molecule, and the alkenyl groups are each preferably bonded to only a silicon atom at a terminal of the molecular chain to make the resulting cured product have favorable flexibility.

The component (A) organopolysiloxane has a viscosity at 25° C. in a range of preferably 10 to 100,000 mPa·s, particularly preferably 50 to 50,000 mPa·s, more preferably 50 to 20,000 mPa·s, more preferably 50 to 2,000 mPa·s. The component (A) an organopolysiloxane is preferably a polydimethylsiloxane.

The component (A-1): Alkenyl Group-Containing Organopolysiloxane has a viscosity at 25° C. in a range of preferably 10 to 100,000 mPa·s, particularly preferably 50 to 10,000 mPa·s, more preferably 50 to 1,000 mPa·s, more preferably 50 to 200 mPa·s. When the viscosity is 10 mPa·s or more, the resulting composition has favorable storage stability. Meanwhile, when the viscosity is 100,000 mPa·s or less, the resulting composition has favorable extensibility. The component (A-1) alkenyl group-Containing Organopolysiloxane is perferably a vinyl-terminated polydimethyl-siloxane.

One kind of the organopolysiloxane of the component (A) may be used alone, or two or more kinds thereof having different viscosity or the like may be used in combination.

One kind of the alkenyl group-containing organopolysiloxane of the component (A-1) may be used alone, or two or more kinds thereof having different viscosity or the like may be used in combination.

### Optional Component (B): Organohydrogenpolysiloxane

The component (B) is an organohydrogenpolysiloxane which has at least two, preferably 2 to 100, hydrogen atoms directly bonded to silicon atoms (Si—H groups) per molecule. This component works as a crosslinking agent of the component (A-1). Specifically, a Si—H group in the component (B) is added to an alkenyl group in the component (A-1) by a hydrosilylation reaction that is promoted by a platinum group metal-based curing catalyst as the component (D) to be described later, thereby forming a three-dimensional network structure having a crosslinked structure. Note that if the number of Si—H groups per molecule in the component (B) is less than 2, no curing occurs.

The organohydrogenpolysiloxane to be used can be shown by the following average structural formula (4), but is not limited thereto.

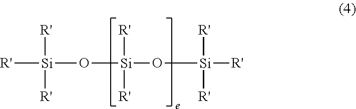

In the formula, each R′ independently represents a hydrogen atom or an unsubstituted or substituted monovalent hydrocarbon group containing no aliphatic unsaturated bond, and at least two R's are hydrogen atoms; e represents an integer of 1 or more.

Examples of the unsubstituted or substituted monovalent hydrocarbon group containing no aliphatic unsaturated bond as R′ other than hydrogen in the formula (4) include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the monovalent hydrocarbon group include ones having 1 to 10 carbon atoms, and particularly typical examples thereof include ones having 1 to 6 carbon atoms. Preferable examples of the monovalent hydrocarbon group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. Additionally, all R's do not have to be the same.

The amount of the component (B) added is such that, relative to 1 mole of alkenyl groups derived from the component (A-1), the amount of Si—H groups derived from the component (B) is 0.1 to 5.0 moles (i.e., the number of moles of the hydrogen atoms directly bonded to silicon atoms is 0.1 to 5.0 times the number of moles of the alkenyl groups derived from the component (A-1)), preferably 0.3 to 2.0 moles, further preferably 0.5 to 1.0 moles. If the amount of the Si—H groups derived from the component (B) is less than 0.1 moles relative to 1 mole of the alkenyl groups derived from the component (A-1), no curing occurs, or the strength of the cured product is so insufficient that the molded product cannot keep the shape and cannot be handled in some cases. Meanwhile, if the amount exceeds 5.0 moles, the cured product may become inflexible and brittle.

One kind of the organopolysiloxane of the component (B) may be used alone, or two or more kinds thereof having different viscosity or the like may be used in combination.

The composition as described above, wherein component (B) could contains (B-1) and (B-2).

Component (B-1) the organic hydrogen-containing polysiloxane is an organic hydrogen-containing polysiloxane having at least 3, preferably 3-100 hydrogen atoms (Si—H groups) directly bonded to silicon atoms in one molecule, wherein the hydrogen content is between 0.5-4 mmol/g, preferably between 0.8-3 mmol/g, more preferably between 1.1-2.7 mmol/g, and more preferably between 1.5-2.3 mmol/g.

Component (B-2) the organic hydrogen-containing polysiloxane of component is an organic hydrogen-containing polysiloxane having 2 hydrogen atoms (Si—H groups) directly bonded to silicon atoms in one molecule, wherein hydrogen content is between 0.01-1.5 mmol/g, preferably between 0.1-1.2 mmol/g, more preferably between 0.3-1.0 mmol/g, more preferably between 0.4-0.8 mmol/g.

The composition as described above, wherein component (B) contains (B-1) and (B-2), and the amount of component (B-1) is between 0.5-3 wt %, preferably 1.5-2.5 wt %, based on the component (A-1) calculated as 100 wt %.

The composition as described above, wherein component (B) contains (B-1) and (B-2), and the amount of component (B-2) is between 10-50 wt %, preferably between 20-40 wt %, based on the component (A-1) calculated as 100 wt %.

### Component (C): Heat Conductive Filler

Heat conductive fillers generally do not contain fumed silica or precipitated silica.

In the composition of the present invention, the content of fumed silica and/or precipitated silica is less than 1 wt % preferably less than 0.1 wt %, calculated based on the total composition of 100 wt %, wherein the BET specific surface area of fumed silica or precipitated silica is between 150-600 m²/g.

Heat conductive filler contains materials generally considered to be a heat conductive filler, including metal, metal oxide, metal nitride and metal hydroxide, further including non-magnetic metal, such as silver or copper or aluminum; metal oxide, such as alumina, silica, magnesia, colcothar, beryllia, titania, or zirconia; metal nitride, such as aluminum nitride, silicon nitride, or boron nitride; metal hydroxide, such as aluminum hydroxide, magnesium hydroxide; artificial diamond, silicon carbide, etc. Additionally, the particle size of 0.1 to 200 μm may be employed. One or two or more kinds thereof may be used as a composite.

The component (C) has to be blended in an amount of 800 to 4,000 parts by mass, preferably 900 to 2,000 parts by mass, more preferably 900 to 1,500 parts by mass, relative to 100 parts by mass of the component (A). If this blend amount is less than 800 parts by mass, the resulting composition has poor heat conductivity. If the blend amount exceeds 2,000 parts by mass, the kneading operability is impaired, and the cured product becomes significantly brittle. In order to obtain higher thermal conductivity and light weight products, the filling rate of the composition is generally greater than or equal to 0.84.

### Optional Component (D): Platinum Group Metal-Based Curing Catalyst

The component (D) is a platinum group metal-based curing catalyst and is not particularly limited, as long as the catalyst promotes an addition reaction of an alkenyl group derived from the component (A-1) and a Si—H group derived from the component (B). Examples of the catalyst include well-known catalysts used in hydrosilylation reaction. Specific examples include: platinum group metal simple substances, such as platinum (including platinum black), rhodium, and palladium; platinum chloride, chloroplatinic acid, and chloroplatinate, such as H₂PtCl₄·nH₂O, H₂PtCl₆·nH₂O, NaHPtCl₆·nH₂O, KHPtCl₆·nH₂O, Na₂PtCl₆·nH₂O, K₂PtCl₄·nH₂O, PtCl₄·nH₂O, PtCl₂, and Na₂HPtCl₄·nH₂O (here, in the formulae, n is an integer of 0 to 6, preferably 0 or 6); alcohol-modified chloroplatinic acid (see specification of U.S. Pat. No. 3,220,972); complexes of chloroplatinic acid with olefin (see U.S. Pat. Nos. 3,159,601 specification, 3,159,662 specification, and 3,775,452 specification); ones obtained by supporting a platinum group metal, such as platinum black and palladium, on a support, such as alumina, silica, or carbon; a rhodium-olefin complex, chlorotris(triphenylphosphine)rhodium (Wilkinson catalyst); complexes of platinum chloride, chloroplatinic acid, or chloroplatinate with a vinyl group-containing siloxane, particularly a vinyl group-no more containing cyclic siloxane; etc.

The component (D) is used in such an amount that the platinum group metal element content is 0.1 to 1,000 ppm relative to the component (A-1) based on mass. If the content is less than 0.1 ppm, sufficient catalyst activity is not obtained. If the content exceeds 1,000 ppm, the cost is merely increased without enhancing the effect of promoting the addition reaction, and the catalyst remaining in the cured product may decrease the insulating property, too.

Component (E-1): an alkoxysilane compound shown by the following formula (1),

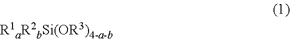

in formula (1)
each R¹ independently represents an alkyl group having 1 to 3 carbon atoms, preferably methyl, ethyl,
each R² independently represents an unsubstituted or substituted hydrocarbon group having 1 to 3 carbon atoms, preferably an unsubstituted or substituted alkyl group having 1 to 3 carbon atoms, preferably methyl, ethyl,
each R³ independently represents an alkyl group having 1 to 3 carbon atoms, preferably methyl, ethyl,
a represents an integer of 1 to 3, and b represents an integer of 0 to 2, provided that a+b is an integer of 1-3; preferably a is 1 and b is 0.

The component (E-1) is preferably an alkoxysilane containing an alkyl group having 1 to 3 carbon atoms; more preferably a trialkoxysilane containing an alkyl group having 1 to 3 carbon atoms; more preferably methyltrimethoxysilane, methyltriethoxysilane, methyltripropoxysilane, propyltrimethoxysilane, propyltriethoxysilane; more preferably methyltrimethoxysilane silane, methyltriethoxysilane.

As the surface treatment agent, the component (E-1) may be blended alone or in combination.

There are no particular restrictions on the surface treatment method using component (E-1) and component (E-2). The heat conductive inorganic filler in component (D) can, for example, be subjected to a direct treatment method, integral blending method, or dry concentrate method. Direct treatment methods include the dry method, slurry method, and spray method. Integral blending methods include the direct method and the master batch method. Drying methods include the slurry method and the direct method. Preferably, component (D) and component (E-1) component (E-2) are mixed together either all at once or in multiple stages beforehand using a conventional mixing device.

The surface treatment method with component (E-1) and component (E-2) in the present invention is preferably the direct treatment method and more preferably a surface treatment method with heat in which component (D) is mixed with component (E-1) and component (E-2) and heated (base heat). Specifically, after uniformly mixing component (D) or some of component (D) with component (E-1) component (E-2) and, optionally, with some of primary components (A) or (B), and the remaining component (D) can be stirred into the mixture under heat at 100 to 200° C. and preferably under reduced pressure. The temperature conditions and stirring time can be set based on the amount of sample used but is preferably 90 to 180° C. and 0.25 to 10 hours.

There are no particular restrictions on the mixing device, which can be a single-shaft or twin-shaft continuous mixer, a two-roll mixer, a Ross mixer, a Hobart mixer, a dental mixer, a planetary mixer, a kneader mixer, or a Henschel mixer.

### Component (F): Property-Imparting Agent

As a component (F), it is possible to add an organopolysiloxane having a viscosity at 25° C. of 10 to 100,000 mPa·s and shown by the following formula (3),

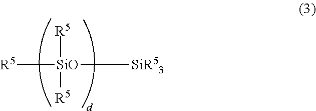

where each R⁵ independently represents a monovalent hydrocarbon group having 1 to 10 carbon atoms and no aliphatic unsaturated bond; and d represents an integer of 5 to 2,000.

The component (F) is used as appropriate in order to impart properties as a viscosity adjuster, plasticizer, and so forth for the thermal conductive silicone composition, but is not limited thereto. One kind of these may be alone, or two or more kinds thereof may be used in combination.

Each R⁵ independently represents an unsubstituted or substituted monovalent hydrocarbon group having 1 to 10 carbon atoms. Examples of R⁵ include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the monovalent hydrocarbon group include ones having 1 to 10 carbon atoms, and particularly typical examples thereof include ones having 1 to 6 carbon atoms. Preferable examples of the monovalent hydrocarbon group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. A methyl group and a phenyl group are particularly preferable. d is preferably an integer of 5 to 2,000, particularly preferably an integer of 10 to 1,000, from the viewpoint of required viscosity.

Moreover, the viscosity at 25° C. is preferably 10 to 100,000 mPa·s, particularly preferably 100 to 10,000 mPa·s. When the viscosity is 10 mPa·s or more, the cured product of the resulting composition hardly exhibits oil bleeding. When the viscosity is 100,000 mPa·s or less, the resulting thermal conductive silicone composition has suitable flexibility.

When the component (F) is added to the inventive thermal conductive silicone composition, the addition amount is not particularly limited, could be 10 to 100 parts by mass relative to 100 parts by mass of the component (A). When the addition amount is in this range, this makes it easy to maintain the favorable flowability and operability of the thermal conductive silicone composition before curing, and to fill the composition with the heat conductive filler of the component (C).

In the inventive thermal conductive silicone composition, the dosage of the component (F) is preferably lower than 0.1 parts by mass, more preferably lower than 0.01 parts by mass, relative to 100 parts by mass of the component (A). In this way, it is possible to avoid oil leakage and contamination of the substrate of the thermally conductive silicone composition.

### Optional Component (G): Reaction Inhibitor

As a component (G), an addition reaction inhibitor is usable. As the addition reaction inhibitor, any of known addition reaction inhibitors used in usual addition reaction-curable silicone compositions can be employed. Examples thereof include acetylene compounds, such as 1-ethynyl-1-hexanol and 3-butyn-1-ol, various nitrogen compounds, organophosphorus compounds, oxime compounds, organochlorine compounds, etc.

When the component (G) is blended, the use amount is preferably 0.01 to 1 parts by mass, more preferably 0.1 to 0.8 parts by mass, relative to 100 parts by mass of the component (A-1). With such a blend amount, the curing reaction proceeds sufficiently, and the molding efficiency is not impaired.

### Other Components

The inventive thermal conductive silicone composition may be further blended with other component(s), as necessary. Examples of the blendable optional components include heat resistance improvers, such as iron oxide and cerium oxide; colorants; release agents; etc.

### EMBODIMENTS

Thermal Conductive Silicone Cured Product, and Production Method Therefor A thermal conductive silicone cured product (thermally-conductive resin molded product) according to the present invention is a cured product of the above-described thermal conductive silicone composition. The curing conditions of curing (molding) the thermal conductive silicone composition may be the same as those for known addition reaction-curable silicone rubber compositions. For example, the thermal conductive silicone composition is sufficiently cured at normal temperature, too, but may be heated as necessary. Preferably, the thermal conductive silicone composition is subjected to addition curing at 100 to 120° C. for 8 to 12 minutes. Such a cured product (molded product) of the present invention is excellent in thermal conduction.

### Heat Conductivity of Molded Product

The inventive molded product has a heat conductivity of preferably 2.0 W/m-K or more, which is a measurement value measured at 25° C. by hot disc method. The product having a heat conductivity of 2.0 W/m-K or more is applicable to heat-generating members which generate large amounts of heat. Note that such a heat conductivity can be adjusted by coordinating the type of the heat conductive filler or combination of the particle sizes.

### Hardness of Molded Product

The inventive molded product is tested by a Zwick hardness tester. Note that such a hardness can be adjusted by changing the proportions of the component (A-1) and the component (B) to adjust the crosslinking density.

According to DIN53019, an Anton Paar MCR302 instrument was used to test the kinematic viscosity and static viscosity of the composition of the present invention.

Components (A) to (G) used in the following Examples and Comparative Examples are shown below.

### Component (A):

(A-1) Component, an organopolysiloxane shown by the following formula (5), wherein X represents a vinyl group, and n represents the number resulting in the viscosity of 120 m Pa·s.

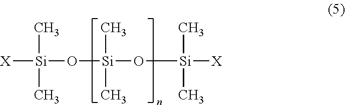

### Component (B):

(B-1) a side chain hydrogenpolysiloxane shown by the following formula (6), the hydrogen content is 1.7 mmol/g.

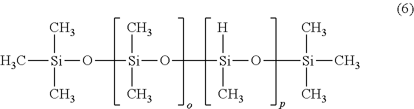

(B-2) a terminated hydrogenpolysiloxane shown by the following formula (7), wherein X represents hydrogen. The hydrogen content is 0.53 mmol/g.

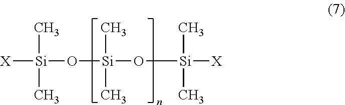

### Component (C):

(C-1) aluminum hydroxide with an average particle diameter of 1.5 μm
(C-2) aluminum hydroxide with an average particle diameter of 25 μm
(C-3) aluminum hydroxide with an average particle diameter of 90 μm
(C-5) alumina with an average particle diameter of 5 μm
(C-6) alumina with an average particle diameter of 40 μm

### Component (E-2):

Single-ended hydroxyl silicone oil 1,

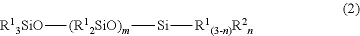

in formula (2), R¹ is methyl, R² is hydroxy, m is bwen 9-15, n=1,
viscosity is between 15-30 mPa·s, according to NMR measurement Mn is between 700-1200 g/mol and the hydroxyl value is between 1.5-2.5 wt %.

### Component (G):

ethynyl methylidene carbinol as an addition reaction inhibitor.

The above-mentioned materials are provided by Wacker Chemie AG.

The components were added in predetermined amounts shown later under Examples and Comparative Examples in Table 1 or 2 and kneaded with a planetary mixer for 30-60 minutes at 90° C.

### Molding Method

After mixture, the compositions in Table 1 are obtained.

The obtained compositions in Table 2 were each poured into a mold with a size of 60 mm×60 mm×6 mm and molded using a press molding machine at 100° C. for 60 minutes.

### Evaluation Methods Heat Conductivity:

The obtained compositions in Table 1 and Table 2 were each poured into a mold with a size of 60 mm×60 mm×6 mm and were used to measure the heat conductivity.

Under conditions of 100° C. and 60 minutes, the compositions obtained in the following Examples and Comparative Examples in Table 2 were cured into sheet form with a thickness of 6 mm. Two sheets from each composition were used to measure the heat conductivity with a thermal conductivity meter (product name: TC3000E, manufactured by Xi'an Xiatech Electronics Co., Ltd.).

### Hardness:

The compositions obtained in the following Examples and Comparative Examples were cured into sheet form with a thickness of 6 mm as described above. Two sheets from each composition were stacked on each other and measured by a Zwick hardness tester to get a Shore00C value.

### Density:

The measurement was performed by Mettler Toledo ML204.

TABLE 1
Thermally Conductive Composition

| | C. Ex. 1 | C. Ex. 2 | Ex. 3 | Ex. 4 | C. Ex. 5 |
|---|---|---|---|---|---|
| double-ended hydroxyl | | | | | 0.62 |
| polydimethylsiloxane, | | | | | |
| viscosity of 40 mPa · s | | | | | |
| (E-2) | 0.83 | | 0.62 | 0.41 | |
| Methyltriethoxysilane | | 0.83 | 0.21 | 0.41 | 0.21 |
| Methyltrimethoxysilane | | | | | |
| n-Octyltriethoxysilane | | | | | |
| Hexadecyltrimethoxysilane | | | | | |
| (A-1) | 19.40 | 19.40 | 19.40 | 19.40 | 19.40 |
| (C-1) | 44.78 | 44.78 | 44.78 | 44.78 | 44.78 |
| (C-2) | 45.00 | 45.00 | 45.00 | 45.00 | 45.00 |
| (C-3) | 90.00 | 90.00 | 90.00 | 90.00 | 90.00 |
| sum [g] | 200.00 | 200.00 | 200.00 | 200.00 | 200.01 |
| Filling rate [%] | 89.89 | 89.89 | 89.89 | 89.89 | 89.89 |
| D = 1 (1/s) | 406 800 | 376 400 | 237 900 | 320 600 | 2 157 000 |
| viscosity [mPa · s] | | | | | |
| D = 10 (1/s) | 199 400 | 301 300 | 182 000 | 221 600 | 441 000 |
| viscosity [mPa · s] | | | | | |
| TI = D1/D10 | 2.04 | 1.25 | 1.31 | 1.45 | 4.89 |
| Thermal Conductivity | 3.05 | 3.50 | 3.38 | 3.43 | 3.11 |
| TC [W/mK] | | | | | |

| | Ex. 6 | C. Ex. 10 | C. Ex. 11 |
|---|---|---|---|
| double-ended hydroxyl | | | |
| polydimethylsiloxane, | | | |
| viscosity of 40 mPa · s | | | |
| (E-2) | 0.62 | 0.41 | 0.41 |
| Methyltriethoxysilane | | | |
| Methyltrimethoxysilane | 0.21 | | |
| n-Octyltriethoxysilane | | 0.41 | |
| Hexadecyltrimethoxysilane | | | 0.41 |
| (A-1) | 19.40 | 19.40 | 19.40 |
| (C-1) | 44.78 | 44.78 | 44.78 |
| (C-2) | 45.00 | 45.00 | 45.00 |
| (C-3) | 90.00 | 90.00 | 90.00 |
| sum [g] | 200.01 | 200.00 | 200.00 |
| Filling rate [%] | 89.89 | 89.89 | 89.89 |
| D = 1 (1/s) | 388 700 | 413 000 | 397 100 |
| viscosity [mPa · s] | | | |
| D = 10 (1/s) | 255 300 | 222 900 | 176 100 |
| viscosity [mPa · s] | | | |
| TI = D1/D10 | 1.52 | 1.85 | 2.25 |
| Thermal Conductivity | 2.95 | 3.35 | 3.52 |
| TC [W/mK] | | | |

In Table 1, when the combination of (E-1) component and (E-2) component is used, the composition can obtain lower viscosity under low-speed shearing and high-speed shearing conditions, especially, The thixotropic value TI=D1/D10 of Ex.3, Ex.4, Ex.6 is lower, below 1.7.

TABLE 2
Heat Conductive Potting composition

| | Ex. 12A | C. Ex. 13A | | Ex. 12B | C. Ex. 13B |
|---|---|---|---|---|---|
| (A-1) | 15.16 | 15.16 | (A-1) | 4.99 | 4.99 |
| (D) | 0.05 | 0.05 | (B-2) | 7.06 | 7.06 |
| | | | (B-1) | 0.98 | 0.98 |
| | | | (G) | 0.29 | 0.29 |
| (C-5) | 29.27 | 29.27 | (C-5) | 29.91 | 29.91 |
| (C-6) | 55.12 | 55.12 | (C-6) | 56.37 | 56.37 |
| (E-2) | 0.3 | 0.3 | (E-2) | 0.3 | 0.3 |
| Methyltriethoxysilane | 0.1 | | Methyltriethoxysilane | 0.1 | |
| Hexadecyltrimethoxysilane | | 0.1 | Hexadecyltrimethoxysilane | | 0.1 |
| Total | 100 | 100 | Total | 100 | 100 |
| D = 1 (1/s) | 3 675 | 6 212 | D = 1 (1/s) | 9 048 | 9 643 |
| viscosity [mPa · s] | | | viscosity [mPa · s] | | |
| D = 10 (1/s) | 3 312 | 3 600 | D = 10 (1/s) | 5 683 | 5 148 |
| viscosity [mPa · s] | | | viscosity [mPa · s] | | |
| TI = D1/D10 | 1.11 | 1.73 | TI = D1/D10 | 1.59 | 1.87 |

| | Ex. 12 | C. Ex. 13 |
|---|---|---|
| Hardness, Shore 00 | 50 | 51 |
| Density [g/cm³] | 2.66 | 2.66 |
| Thermal Conductivity | 2.03 | 2.01 |
| TC [W/mk] | | |

In Table 2, component A and component B are stirred and mixed at a ratio of 1:1. When the shear rate is 1 (1/s), the initial viscosity of the product obtained in Ex. 12 after mixing is about 6200 mPa·s; when the shear rate is 10 (1/s), the initial viscosity after mixing is about 4300 mPa·s.

The thixotropic index TI of Component Aand Component B of Ex.12 is low (both lower than 1.7), and the fluidity is excellent, which can be used for potting of electronic products containing fine parts. On the other hand, the thixotropic index TI of component A and component B of C.Ex.13 is higher, which is prone to the disadvantage of insufficient flow during the potting process. And the products obtained from Ex.12 have slightly higher thermal conductivity and better property.

1-11. (canceled)

12. A composition, which contains:
a component (A), that is an organopolysiloxane, preferably a component (A-1) that is an organopolysiloxane having two or more alkenyl groups per molecule;
optional a component (B) that is an organohydrogenpolysiloxane having two or more hydrogen atoms directly bonded to silicon atoms and is contained in such an amount that the number of moles of hydrogen atoms directly bonded to silicon atoms in the component (B) is 0.1 to 5.0 times the number of moles of alkenyl groups derived from the component (A-1);
a component (C) that is a heat conductive filler,
wherein the filling rate of the heat conductive filler is greater than or equal to 0.80, preferably greater than or equal to 0.84, preferably greater than or equal to 0.88, preferably greater than or equal to 0.89, preferably greater than or equal to 0.90;
optional a component (D) that is a platinum group metal-based curing catalyst having a platinum group metal element content of 0.1 to 1,000 ppm relative to the component (A-1) based on mass,
a component (E-1) that is an alkoxysilane compound shown by the following formula (1); and 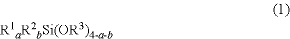
in the formula (1)
each R¹ independently represents an alkyl group having 1 to 3 carbon atoms, preferably methyl, ethyl,
each R² independently represents an unsubstituted or substituted hydrocarbon group having 1 to 3 carbon atoms, preferably methyl, ethyl,
each R³ independently represents an alkyl group having 1 to 6 carbon atoms, preferably an alkyl group having 1 to 3 carbon atoms, more preferably methyl, ethyl,
a represents an integer of 1 to 3, and b represents an integer of 0 to 2, provided that a+b is an integer of 1 to 3,
a component (E-2) that is a polysiloxane represented by the following general formula (2), 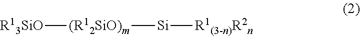
in the formula (2),
each R¹ independently represents a hydrocarbon group with 1-6 carbon atoms, preferably s an alkyl or alkenyl group having 1 to 3 carbon atoms, preferably methyl, ethyl, propyl, vinyl, more preferably methyl;
each R² independently represents —OH or —(CH₂)ₚOH, p is an integer from 1 to 3, preferably hydroxyl;
m≤50, more preferably m≤20, more preferably 6≤m≤18;
n is an integer, preferably n is 1-3, more preferably n is 1.

13. The composition of claim 12, wherein the thixotropic index (Ti) at 25° C. is preferably 1.70 or less, preferably 1.05-1.70, more preferably 1.20-1.70, more preferably 1.30-1.55.

14. The composition of claim 12, wherein according to DIN53019, the viscosity of ingredient (E-2) at 25° C. is 500 mPa·s or less, preferably 300 mPa·s or less, more preferably 100 mPa·s or less, more preferably 50 mPa·s or less, more preferably between 10-40 mPa·s.

15. The composition of claim 12, wherein the component (E-1) is preferably an alkoxysilane containing an alkyl group having 1 to 3 carbon atoms; more preferably a trialkoxysilane containing an alkyl group having 1 to 3 carbon atoms; more preferably methyltrimethoxysilane, methyltriethoxysilane, methyltripropoxysilane, propyltrimethoxysilane, propyltriethoxysilane; more preferably methyltrimethoxysilane silane, methyltriethoxysilane.

16. The composition of claim 12, wherein the ratio of (E-1) component to (C) component is between 0.02-1.00 wt %, preferably between 0.05-0.50 wt %, more preferably between 0.08-0.20 wt %, more preferably between 0.08-0.15 wt %.

17. The composition of claim 12, wherein the weight ratio of (E-2) component to (E-1) component is between 0.5-10, preferably between 0.8-6; preferably between 2-4; more preferably between 2.5-3.5.

18. The composition of claim 12, wherein the ratio of (E-2) component to (C) component is between 0.05-1.00 wt %, preferably between 0.08-0.80 wt %, more preferably between 0.08-0.60 wt %, more preferably between 0.10-0.40 wt %.

19. The composition of claim 12, wherein the ratio of the sum of components (E-1) and (E-2) to component (C) is between 0.05-2.00 wt %, preferably between 0.08-1.20 wt %, more preferably between 0.10-1.00 wt %, more preferably between 0.10-0.80 wt %, more preferably between 0.20-0.60 wt %.

20. Use of the composition of claim 12 in the field of potting.

21. A thermally conductive member comprising the composition according to claim 12 or a cured product thereof.

22. A heat-dissipating structure comprising the thermally conductive member according to claim 21.
